(19) United States
(12) Patent Application Publication
(10) Pub. No.: US 2026/0142508 A1
(43) Pub. Date: May 21, 2026

(54) STATOR, MOTOR, COMPRESSOR, AND REFRIGERATION CYCLE APPARATUS

(71) Applicant: Mitsubishi Electric Corporation, Tokyo (JP)

(72) Inventor: Yuki HIGASHI, Tokyo (JP)

(21) Appl. No.: 18/705,875

(22) PCT Filed: Dec. 13, 2021
(86) PCT No.: PCT/JP2021/045746

§ 371 Date: Apr. 29, 2024

(51) Int. Cl. H02K 1/16; H02K 1/18

(52) U.S. Cl. CPC H02K 1/165; H02K 1/185; H02K 2213/03

(57) ABSTRACT

A core back has an outer circumference having first and second contact portions in contact with a shell and a non-contact portion not in contact with the shell. The first contact portion is located on a first side of the non-contact portion, and the second contact portion is located on a second side of the non-contact portion. A root portion of a first tooth has a first corner portion on the first side and a second corner portion on the second side. A shortest distance La from the first corner portion to the outer circumference and a shortest distance Lb from the second corner portion to the outer circumference satisfy La<Lb. A shortest distance Da from the first corner portion to the first contact portion and a shortest distance Db from the second corner portion to the second contact portion satisfy Da>Db. Radii of curvature Ra and Rb of the first and second corner portion satisfy Ra<Rb.

### CROSS-REFERENCE TO RELATED APPLICATION

This application is a U.S. national stage application of PCT/JP2021/045746 filed Dec. 13, 2021, the contents of which are incorporated herein by reference.

### TECHNICAL FIELD

The present disclosure relates to a stator, a motor, a compressor, and a refrigeration cycle apparatus.

### BACKGROUND

A stator includes a stator core, and a coil wound on the stator core. The stator core includes an annular core back, and teeth extending from the core back inward in the radial direction. The core back is fixed inside a cylindrical shell by shrink fitting or the like. Patent Reference 1 proposes a stator in which an outer circumference of a core back has a contact portion in contact with a shell and a non-contact portion not in contact with the shell, and the contact portion has a larger area than the non-contact portion.

### PATENT REFERENCE

Patent Reference 1: Japanese Patent Application Publication No. 2008-193778 (see Abstract)

In a conventional stator, however, stress may be concentrated on comer portions at the root of the tooth. When such stress concentration occurs, magnetic resistance in the stator locally increases, and may cause a decrease in motor efficiency. In addition, when the stator is deformed by stress concentration, the distance between the stator and the rotor decreases, and may cause vibration and noise.

### SUMMARY

The present disclosure is made to solve the problem described above, and an object of the present disclosure is to suppress stress concentration in a stator.

A stator according to the present disclosure includes a stator core including a core back having an annular shape about an axis and a plurality of teeth extending from the core back inward in a radial direction about the axis, the stator core being fixed inside a shell. The core back has an outer circumference facing the shell, and the outer circumference has a first contact portion and a second contact portion which are in contact with the shell and a non-contact portion which is not in contact with the shell. In a circumferential direction about the axis, the first contact portion is located on a first side of the non-contact portion, and the second contact portion is located on a second side of the non-contact portion. The plurality of teeth include a first tooth. The first tooth has a root portion connecting to the core back, and the root portion has a first corner portion on the first side and a second corner portion on the second side. A shortest distance La from the first corner portion to the outer circumference and a shortest distance Lb from the second corner portion to the outer circumference satisfy La<Lb. A shortest distance Da from the first corner portion to the first contact portion and a shortest distance Db from the second corner portion to the second contact portion satisfy Da>Db. A radius of curvature Ra of the first corner portion and a radius of curvature Rb of the second comer portion satisfy Ra<Rb.

According to the present disclosure, since the radius of curvature Rb of the second corner portion is larger than the radius of curvature Ra of the first corner portion, it is possible to suppress stress concentration on the second corner portion where stress is likely to be concentrated most in the stator core. As a result, stress concentration in the stator can be suppress.

### BRIEF DESCRIPTION OF THE DRAWINGS

FIG. 1 is a cross-sectional view illustrating a motor according to a first embodiment.

FIG. 2 is a cross-sectional view illustrating a rotor according to the first embodiment.

FIG. 3 is a cross-sectional view illustrating a stator core according to the first embodiment.

FIG. 4 is a diagram illustrating a portion of the motor according to the first embodiment.

FIG. 5 is a diagram illustrating the portion of the motor according to the first embodiment.

FIG. 6 is a diagram illustrating the stator core and a shell according to the first embodiment.

FIG. 7 is a schematic view illustrating a state of stress concentration in the stator core according to the first embodiment.

FIG. 8 is a schematic view illustrating a state of stress concentration in a stator core of a comparative example.

FIG. 9 is a diagram showing a relationship between Lb/La and stress on each corner portion in the first embodiment.

FIG. 10 is a diagram showing a relationship between (Lb/La)/(Db/Da) and stress on each corner portion in the first embodiment.

FIG. 11 is a diagram illustrating a slot of the stator core and a coil according to the first embodiment.

FIG. 12 is a diagram illustrating a slot of the stator core and a coil of the comparative example.

FIG. 13 is a diagram illustrating an electromagnetic steel sheet from which a stator core and a rotor core are punched.

FIG. 14 is a schematic view for describing a state of deformation of the stator core and the shell.

FIG. 15 is an enlarged view illustrating teeth of a second embodiment.

FIGS. 16(A) and 16(B) are diagrams illustrating two examples of a method for forming a shell of each embodiment.

FIG. 17 is a longitudinal sectional view illustrating a compressor to which the motor of each embodiment is applicable.

FIG. 18 is a diagram illustrating a refrigeration cycle apparatus to which the compressor of FIG. 17 is applicable.

### DETAILED DESCRIPTION

### First Embodiment

### Configuration of Motor

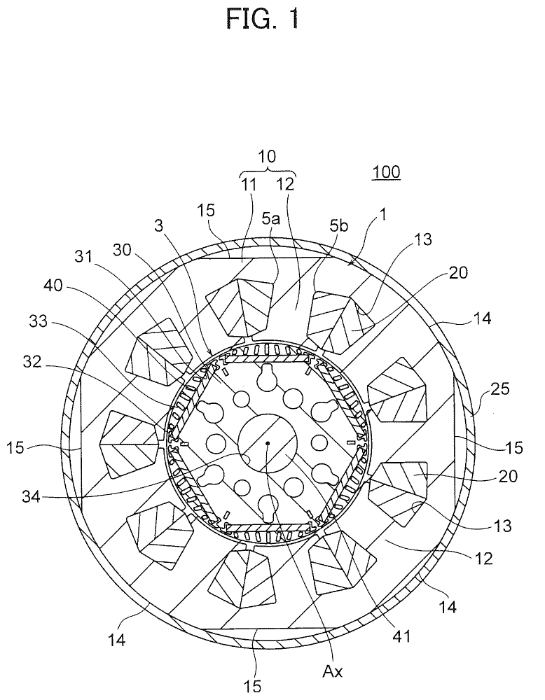

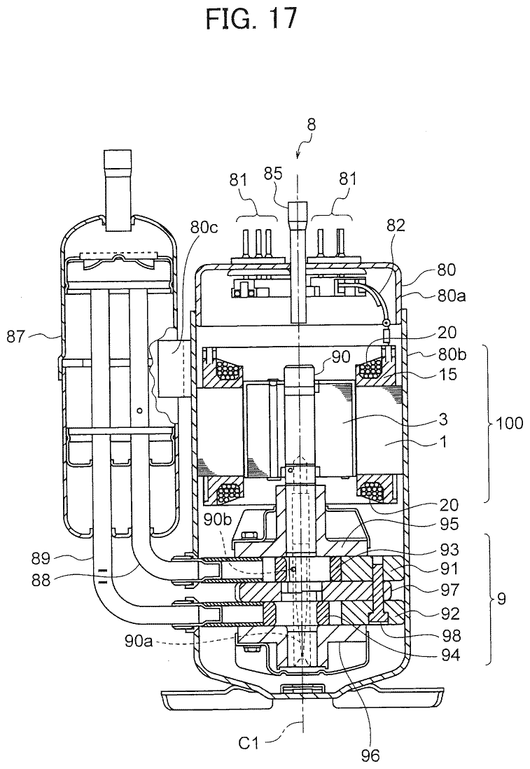

First, a first embodiment will be described. FIG. 1 is a cross-sectional view illustrating a motor 100 according to the first embodiment. The motor 100 illustrated in FIG. 1 is a motor of a so-called inner rotor type, and is used for, for example, a compressor 8 (FIG. 17).

The motor 100 includes a rotor 3 including a shaft 41 serving as a rotation shaft, and a stator 1 surrounding the rotor 3. An air gap of, for example, 0.3 to 1.0 mm is formed between the stator 1 and the rotor 3. The stator 1 is incorporated in a shell 25 that is a cylindrical housing of the compressor 8 (FIG. 17) described later.

In the following description, a direction of an axis Ax that is a rotation center of the shaft 41 will be referred to as an “axial direction”. A radial direction about the axis Ax will be referred to as “radial direction”. A circumferential direction about the axis Ax will be referred to as a “circumferential direction”.

### Configuration of Rotor

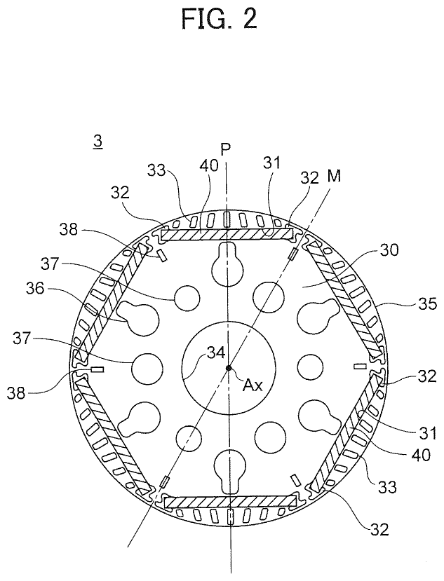

FIG. 2 is a cross-sectional view illustrating the rotor 3. As illustrated in FIG. 2, the rotor 3 includes a rotor core 30 having a cylindrical shape about the axis Ax, and permanent magnets 40 attached to the rotor core 30. The rotor core 30 is obtained by stacking a plurality of electromagnetic steel sheets in the axial direction and fixing the sheets by crimping or the like.

The thickness of each electromagnetic steel sheet is 0.1 to 0.7 mm, and is 0.35 mm in this example. A center hole 34 is formed at the center of the rotor core 30 in the radial direction. The shaft 41 described above is fixed in the center hole 34 of the rotor core 30 by shrink fitting, press fitting, bonding, or the like. The rotor core 30 has an outer circumference 35 having an annular shape.

A plurality of magnet insertion holes 31 in which the permanent magnets 40 are to be inserted are formed along the outer circumference 35 of the rotor core 30. Each magnet insertion hole 31 corresponds to one magnetic pole. The center of the magnet insertion hole 31 in the circumferential direction is a pole center P. A portion between adjacent ones of the magnet insertion holes 31 is an inter-pole portion M. The number of the magnet insertion holes 31 is six in this example. In other words, the number of poles is six. In this regard, the number of poles is not limited to six, and only needs to be two or more. Each of the magnet insertion holes 31 has a V shape projecting inward in the radial direction in a plane orthogonal to the axial direction.

One permanent magnet 40 is inserted in each of the magnet insertion holes 31. Each permanent magnet 40 has a flat-plate shape, has a width in the circumferential direction of the rotor core 30, and has a thickness in the radial direction. Each permanent magnet 40 is magnetized in the thickness direction.

Each permanent magnet 40 is constituted by, for example, a rare earth magnet. The rare earth magnet is, for example, a neodymium magnet containing neodymium (Nd), iron (Fe), and boron (B). Each magnet insertion hole 31 may have, for example, a linear shape, and the number of permanent magnets 40 inserted in each magnet insertion hole 31 only needs to be one or more.

In the rotor core 30, flux barriers 32 that are holes are formed at both ends of each magnet insertion hole 31 in the circumferential direction. A thin portion is formed between each flux barrier 32 and the outer circumference 35 of the rotor core 30. The thickness of the thin portion is set to suppress short-circuit magnetic fluxes flowing between adjacent magnetic poles. The width of the thin portion is set to be equal to the thickness of each electromagnetic steel sheet, for example.

In the rotor core 30, slits 33 are formed between each magnet insertion hole 31 and the outer circumference 35. The slits 33 are formed to control distribution of magnetic fluxes emitted from the permanent magnet 40. In this example, seven slits 33 are symmetrically arranged with respect to the center of each magnet insertion hole 31 (i.e., the pole center) in the circumferential direction. The number and positions of the slits 33 are not limited to those in the example described here. The rotor core 30 does not necessarily have the slits 33.

In the rotor core 30, holes 36 and 37 are formed on the inner side of the magnet insertion holes 31 in the radial direction. The holes 36 and 37 are used as air holes through which refrigerant passes or holes through which jigs are inserted. The number of the holes 36 is equal to the number of poles, and the number of the holes 37 is also equal to the number of poles. The positions of the holes 36 in the circumferential direction coincide with the centers of the magnet insertion holes 31 in the circumferential direction. The positions of the holes 37 in the circumferential direction coincide with the inter-pole portions M. The numbers and positions of the holes 36 and 37 are not limited to those in the example described here. The rotor core 30 does not necessarily have the holes 36 and 37.

Crimping portions 38 for fixing electromagnetic steel sheets of the rotor core 30 are formed on the outer side of the holes 37 in the radial direction. The positions of the crimping portions 38 are not limited to the example described here. The electromagnetic steel sheets of the rotor core 30 may be fixed by a technique other than crimping.

### Configuration of Stator

As illustrated in FIG. 1, the stator 1 includes a stator core 10 surrounding the rotor core 30 from outside in the radial direction, and a winding 20 wound on the stator core 10. The stator core 10 is obtained by stacking a plurality of electromagnetic steel sheets in the axial direction and fixing the electromagnetic steel sheets by crimping or the like. The thickness of each electromagnetic steel sheet is 0.1 to 0.7 mm, and is 0.35 mm in this example.

The stator core 10 includes a core back 11 having an annular shape about the axis Ax, and a plurality of teeth 12 extending from the core back 11 inward in the radial direction. The teeth 12 are arranged at equal intervals in the circumferential direction. The number of teeth 12 is nine in this example. The number of the teeth 12, however, is not limited to nine, and only needs to be two or more. A slot 13 that is a space for accommodating the winding 20 is formed between each two of the teeth 12 adjacent to each other in the circumferential direction. The number of slots 13 is nine, which is equal to the number of the teeth 12.

The winding 20 is formed of a magnet wire serving as a coil, and wound around each of the teeth 12 by concentrated winding. The outer diameter of the magnet wire, that is, the coil diameter, is, for example, 1.0 mm. The number of turns of the winding 20 around one tooth 12 is, for example, 80 turns.

A not-shown insulating portion formed of a resin such as polybutylene terephthalate (PBT) is provided between the stator core 10 and the winding 20. The insulating portion is formed by attaching a resin molded body to the stator core 10 or integrally molding the stator core 10 with a resin. An insulating film formed of a resin such as polyethylene terephthalate (PET) may be provided on the inner surface of each slot 13.

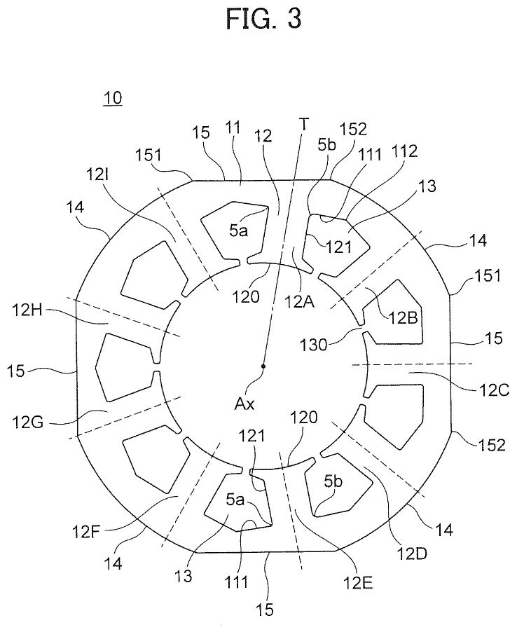

FIG. 3 is a plan view illustrating the stator core 10. As described above, the teeth 12 extend from the core back 11 inward in the radial direction. Each of the teeth 12 has a pair of side portions 121 on both sides in the circumferential direction.

Each of the teeth 12 also includes a tooth tip 120 facing the rotor 3 (FIGS. 1 and 2). The tooth tip 120 projects from the side portions 121 of the tooth 12 to both sides in the circumferential direction. An inner circumference 111 of the core back 11 and the side portion 121 of the tooth 12 face the slot 13. A slot opening 130 is formed between adjacent two of the tooth tips 120.

Contact portions 14 and non-contact portions 15 are alternately formed on the outer circumference of the core back 11 of the stator core 10. Each of the contact portions 14 forms a part of a cylindrical surface about the axis Ax. Each of the non-contact portions 15 forms a plane parallel to the axis Ax. The contact portions 14 are also referred to as arc portions, and the non-contact portions 15 are also referred to as cutout portions.

Four non-contact portions 15 are formed at an interval of 90 degrees about the axis Ax. By forming the four non-contact portions 15, the stator core 10 falls within a square region, which has the advantage of enhancing the yield in punching the electromagnetic steel sheet.

Next, a positional relationship between the teeth 12 and the contact and non-contact portions 14 and 15 will be described. Since the number of the non-contact portions 15 is four and the number of the teeth 12 is nine, the positions of the teeth 12 relative to the non-contact portions 15 vary depending on the teeth 12. In FIG. 3, the nine teeth 12 are referred to as teeth 12A, 12B, 12C, 12D, 12E, 12F, 12G, 12H, and 12I, in a clockwise order from the top tooth 12 in the figure.

A straight line passing through the axis Ax and the center of each tooth 12 in the circumferential direction will be referred to as a tooth center line. In FIG. 3, the tooth center line of the tooth 12A is indicated by character T. The tooth center lines of the teeth 12B through 12I are indicated by broken lines. The tooth 12A is also referred to as a first tooth.

The tooth center line T of the tooth 12A passes through the non-contact portion 15. The tooth center line of the tooth 12B passes through the contact portion 14. The tooth center line of the tooth 12C passes through the non-contact portion 15. The tooth center line of the tooth 12D passes through the contact portion 14. The tooth center line of the tooth 12E passes through the non-contact portion 15. The tooth center line of the tooth 12F passes through the contact portion 14. The tooth center line of the tooth 12G passes through the boundary between the contact portion 14 and the non-contact portion 15. The tooth center line of the tooth 12H passes through the boundary between the contact portion 14 and the non-contact portion 15. The tooth center line of the tooth 12I passes through the contact portion 14.

The tooth center line of the tooth 12C passes through the center of the non-contact portion 15 in the circumferential direction. The tooth center line of each of the other teeth 12A, 12B, and 12D through 12I passes through a position shifted from the center of the contact portion 14 or the non-contact portion 15 in the circumferential direction.

Description will be given to the teeth 12A and 12E each of whose tooth center line T passes through a position shifted from the center of the non-contact portion 15 in the circumferential direction. The teeth 12A and 12E are symmetric with respect to a plane (straight line in FIG. 3) including the axis Ax, and thus, description will be given on the tooth 12A.

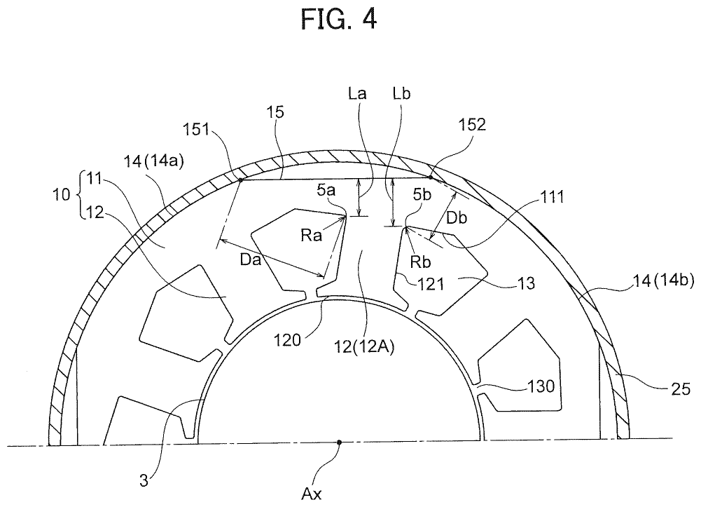

FIG. 4 is a diagram illustrating a portion of the stator core 10 including the tooth 12A, the shell 25, and the rotor 3. With regard to the rotor 3, only the outer circumference of the rotor 3 is shown in FIG. 4. The non-contact portion 15 is located on the outer side of the tooth 12A in the radial direction.

In FIG. 4, the left side is defined as a first side, and the right side is defined as a second side. In both ends of the non-contact portion 15 in the circumferential direction, an end on the first side is defined as a first end 151, and an end on the second side is defined as a second end 152.

In the contact portions 14 on both sides of the non-contact portion 15 in the circumferential direction, the contact portion 14 on the first side of the non-contact portion 15 will be referred to as a first contact portion 14a. The contact portion 14 on the second side of the non-contact portion 15 will be referred to as a second contact portion 14b.

A root portion of the tooth 12A connecting to the core back 11 has a first corner portion 5a on the first side and a second corner portion 5b on the second side.

Each of the corner portions 5a and 5b is formed between the side portion 121 of the tooth 12 and the inner circumference 111 of the core back 11. An angle formed by the side portion 121 of the tooth 12 and the inner circumference 111 of the core back 11 is 90 degrees, but may be less than 90 degrees or larger than 90 degrees.

The first corner portion 5a has a curved shape with a radius of curvature Ra. The second corner portion 5b has a curved shape with a radius of curvature Rb. The radius of curvature Ra of the first corner portion 5a and the radius of curvature Rb of the second corner portion 5b satisfy Ra<Rb.

A shortest distance from the first corner portion 5a to the outer circumference of the stator core 10 is defined as a distance La. A shortest distance from the second corner portion 5b to the outer circumference of the stator core 10 is defined as a distance Lb. The distances La and Lb correspond to widths of the core back 11 at positions of the corner portions 5a and 5b in the circumferential direction.

In this example, the distance La is the shortest distance from the first corner portion 5a to the non-contact portion 15, and the distance Lb is the shortest distance from the second corner portion 5b to the non-contact portion 15.

A shortest distance from the first corner portion 5a to the first contact portion 14a is defined as a distance Da. A shortest distance from the second corner portion 5b to the second contact portion 14b is defined as a distance Db. The distances Da and Db correspond to shortest distances from the corner portions 5a and 5b to positions at which the stator core 10 receives stress from the shell 25.

The distance Da can also be referred to as a distance from the first corner portion 5a to the first end 151 of the non-contact portion 15. The distance Db can also be referred to as a distance from the second corner portion 5b to the second end 152 of the non-contact portion 15.

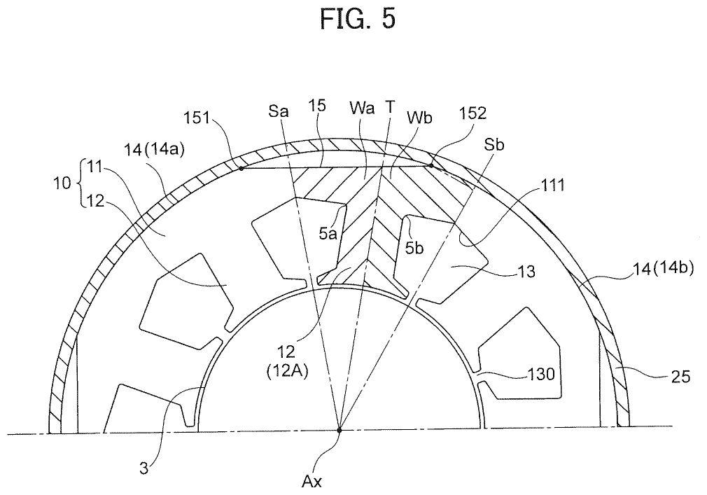

FIG. 5 is a schematic view for describing a shape of a portion of the stator core 10 including the tooth 12A. In two slots 13 on both sides of the tooth 12A in the circumferential direction, a straight line passing through the axis Ax and a center in the circumferential direction of the slot 13 that the first corner portion 5a faces is defined as a slot center line Sa. A straight line passing through the axis Ax and a center in the circumferential direction of the slot 13 that the second corner portion 5b faces is defined as a slot center line Sb.

A portion of the stator core 10 sandwiched between the tooth center line T and the slot center line Sa is defined as a first region Wa. A portion of the stator core 10 sandwiched between the tooth center line T and the slot center line Sb is defined as a second region Wb. The first region Wa and the second region Wb are asymmetric with respect to the tooth center line T.

### Action

Next, the action of the first embodiment will be described. Stress applied to the stator core 10 will be described. The stator core 10 is fixed to the shell 25, which is a rigid body, by shrink fitting. In the shrink fitting, the stator core 10 is inserted inside the shell 25 whose inner diameter is enlarged beforehand by heating. When the shell 25 is air-cooled and the inner diameter of the shell 25 returns to the original inner diameter, stress from the shell 25 is applied to the stator core 10.

A portion of the stator core 10 including the tooth 12A has an asymmetric shape with respect to the tooth center line T as described above. That is, as illustrated in FIG. 4, the distance La from the first corner portion 5a to the outer circumference of the stator core 10 and the distance Lb from the second corner portion 5b to the outer circumference of the stator core 10 satisfy La<Lb. The distance Da from the first corner portion 5a to the first contact portion 14a and the distance Db from the second corner portion 5b to the second contact portion 14b satisfy Da>Db.

Thus, larger stress is concentrated on the second corner portion 5b than on the first corner portion 5a. When stress is concentrated, magnetic resistance of electromagnetic steel sheets as a core material increases. Since the second corner portion 5b is located on a magnetic path from the tooth 12A to the core back 11, the increase in magnetic resistance leads to a decrease in motor efficiency.

In addition, when stress is concentrated on the second corner portion 5b, the tooth 12 is deformed and the distance between the tooth tip 120 and the rotor 3 decreases. This may cause vibration and noise during rotation of the rotor 3.

Thus, in this embodiment, the radius of curvature Rb of the second corner portion 5b where stress tends to be concentrated is made larger than the radius of curvature Ra of the first corner portion 5a. In other words, Ra<Rb is satisfied.

Accordingly, stress concentration on the second corner portion 5b can be reduced, and a decrease in motor efficiency and occurrence of vibration and noise can be suppressed.

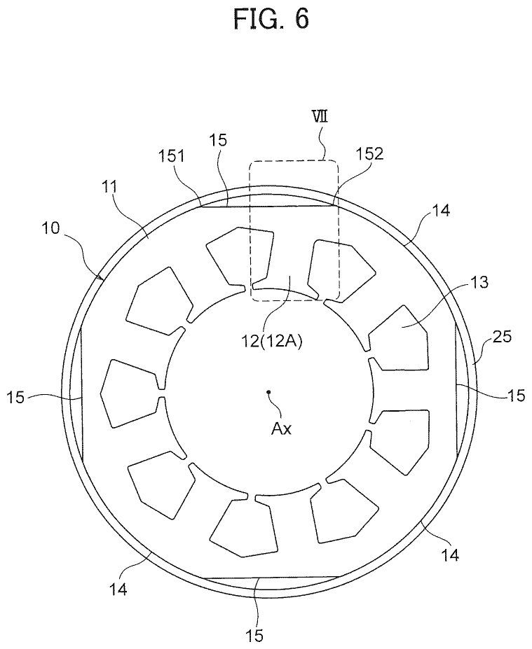

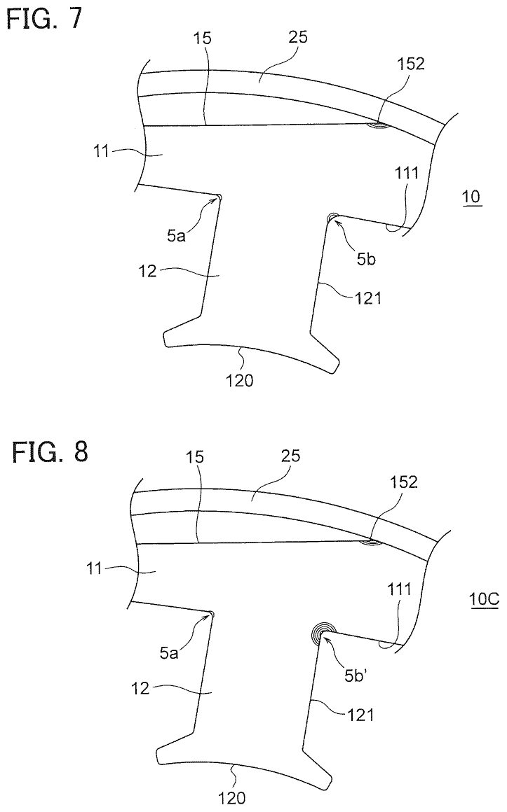

Analysis results of stress distribution will be described here. FIG. 6 is a diagram illustrating the stator core 10 together with the shell 25. FIG. 7 is a diagram showing the analysis results of stress on a portion indicated by a square VII in FIG. 6, in the stator core 10 according to the first embodiment. FIG. 8 is a diagram showing analysis results of stress on a portion indicated by the square VII in FIG. 6, in the stator core 100 of a comparative example.

In the stator core 10C of the comparative example, a radius of curvature Ra of a first corner portion 5a is equal to a radius of curvature Rb of a second corner portion 5b′. In other respects, the stator core 10C is configured in a similar manner to the stator core 10 of the first embodiment.

As illustrated in FIG. 8, in the stator core 10C of the comparative example, stress concentration on the first corner portion 5a is small, but large stress is observed on the second corner portion 5b′.

On the other hand, as illustrated in FIG. 7, in the stator core 10 of the first embodiment, stress concentration on the first corner portion 5 is similar to that in the comparative example, but stress concentration on the second corner portion 5b is significantly reduced.

Incidentally, in FIGS. 7 and 8, stress concentration is also observed on a portion of the non-contact portion 15 including the second end 152. This is because the second end 152 is a boundary between the contact portion 14 in contact with the shell 25 and the non-contact portion 15 not in contact with the shell 25. However, a flow of magnetic fluxes is small in this portion, and thus the stress concentration is less likely to cause decrease in the motor efficiency.

Next, description will be given to analysis results of stress on the first corner portion 5a and the second corner portion 5b obtained by changing Lb/La, which is a ratio of the distance Lb to the distance La.

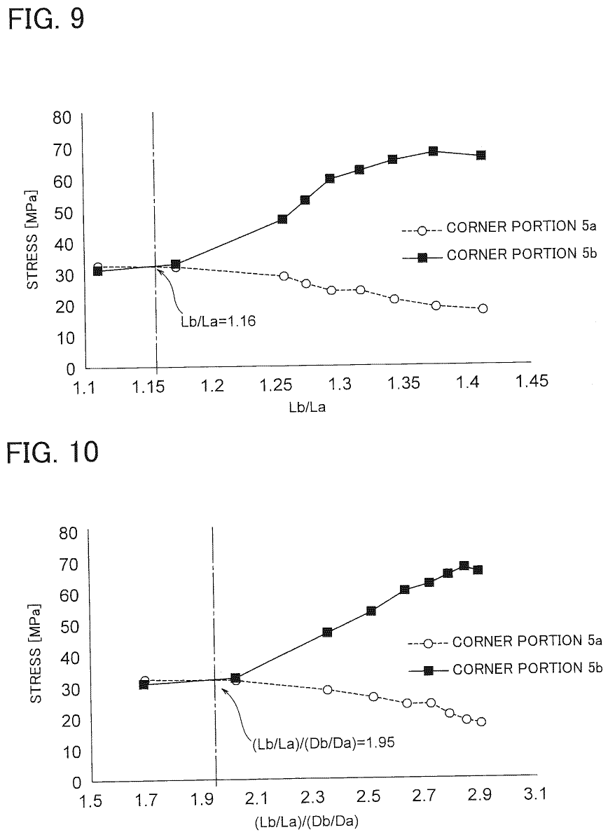

FIG. 9 shows a relationship between Lb/La and stress on the corner portions 5a and 5b. The horizontal axis represents Lb/La, and the vertical axis represents stress [MPa]. As shown in FIG. 9, stress on the first corner portion 5a decreases as Lb/La increases, and stress on the second corner portion 5b increases as Lb/La increases.

This is because as Lb/La increases, asymmetry of the shape of the core back 11 on the outer circumference side of the tooth 12A increases, and thus stress concentration on the second corner portion 5b increases. In particular, in a range where Lb/La is larger than 1.16, stress on the second corner portion 5b is larger than stress on the first corner portion 5a.

On the other hand, in a range where Lb/La is smaller than 1.16, stress on the second corner portion 5b is substantially equal to and slightly smaller than stress on the first corner portion 5a. This is because the shape of the core back 11 on the outer circumference side of the tooth 12A is close to symmetric, and stress on the second corner portion 5b is converged to a constant value.

Thus, it is understood that the effect of reducing stress concentration on the second corner portion 5b by making the radii of curvature Ra and Rb of the corner portions 5a and 5b satisfy Ra<Rb is especially significant in the range where the Lb/La is larger than 1.16.

In the above analysis, the distances Da and Db change with changes of the distances La and Lb. The distance Da changes linearly with respect to the change of the distance La, whereas the distance Db is at minimum when the distance Lb is at a certain value. For this reason, the description will be given to a relationship between (Lb/La)/(Db/Da), which is a ratio of Lb/La to Db/Da, and changes of stress on the corner portions 5a and 5b.

FIG. 10 shows a relationship between (Lb/La)/(Db/Da) and stress on the corner portions 5a and 5b. The horizontal axis represents (Lb/La)/(Db/Da), and the vertical axis represents stress [MPa]. As shown in FIG. 10, stress on the first corner portion 5a decreases as (Lb/La)/(Db/Da) increases, and stress on the second corner portion 5b increases as (Lb/La)/(Db/Da) increases.

In a range where (Lb/La)/(Db/Da) is larger than 1.95, stress on the second corner portion 5b is larger than stress on the first corner portion 5a. In a range where (Lb/La)/(Db/Da) is smaller than 1.95, stress on the first corner portion 5a is larger than stress on the second corner portion 5b.

Thus, it is understood that the effect of reducing stress concentration on the second corner portion 5b by making the radii of curvatures Ra and Rb of the corner portions 5a and 5b satisfy Ra<Rb is significant especially in the range where (Lb/La)/(Db/Da) is larger than 1.95.

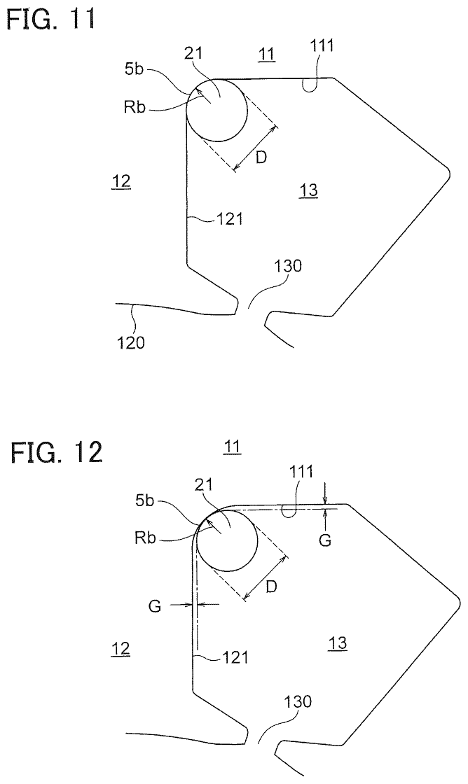

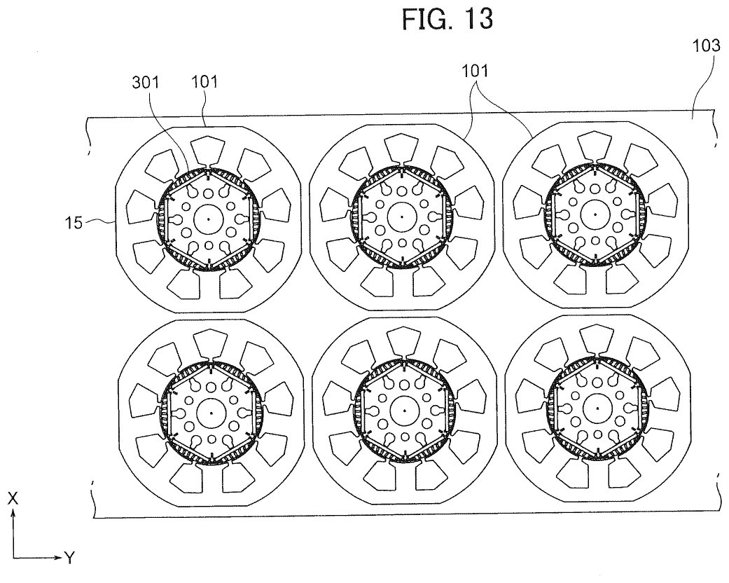

Then, a relationship between the radius of curvature Rb of the second corner portion 5b and a coil diameter of the winding 20 will be described. FIGS. 11 and 12 are enlarged views illustrating a portion of the stator core 10 including the second corner portion 5b. A coil 21 constituting the winding 20 includes a copper or aluminum conductor covered with an insulating film. The coil 21 has an outer diameter D.

FIG. 11 illustrates a configuration example in which the radius of curvature Rb of the second corner portion 5b is smaller than or equal to the radius D/2 of the coil 21. FIG. 12 illustrates a configuration example in which the radius of curvature Rb of the second corner portion 5b is larger than the radius D/2 of the coil 21. In each of FIGS. 11 and 12, the radius of curvature Rb of the second corner portion 5b and the outer diameter D of the coil 21 are illustrated in an enlarged scale.

As described above, in order to suppress stress concentration on the second corner portion 5b, the radius of curvature Rb of the second corner portion 5b is preferably large. On the other hand, in the case where the radius of curvature Rb of the second corner portion 5b is larger than the radius D/2 of the coil 21 as illustrated in FIG. 12, a gap G is formed between the coil 21 disposed at the second corner portion 5b and the side portion 121 of the tooth 12, and another gap G is also formed between this coil 21 and the inner circumference 111 of the core back 11.

When such gaps G are formed, the coil 21 of the first layer wound around the teeth 12 is not linearly arranged, and it is difficult to wound the coil 21 of the second and subsequent layers in an aligned manner. As a result, a space factor in the slot 13 decreases. The decrease in space factor in the slot 13 leads to an increase of a copper loss.

On the other hand, in the case where the radius of curvature Rb of the second corner portion 5b is smaller than or equal to the radius D/2 of the coil 21 as illustrated in FIG. 11, no gaps G are formed between the coil 21 disposed at the second corner portion 5b and the side portion 121 of the tooth 12 and between this coil 21 and the inner circumference 111 of the core back 11. Thus, the coil 21 can be wound around the teeth 12 in an aligned manner, and a decrease in space factor in the slot 13 can be suppressed.

For this reason, the radii of curvatures Ra and Rb of the corner portions 5a and 5b preferably satisfy Ra<Rb≤D/2. When the radii of curvatures Ra and Rb of the corner portions 5a and 5b are within this range, it is possible to suppress a decrease in space factor in the slot 13 while suppressing stress concentration.

FIG. 13 is a diagram illustrating an electromagnetic steel sheet 103 from which the stator core 10 and the rotor core 30 are punched. In FIG. 13, the electromagnetic steel sheets constituting the stator core 10 are referred to as core sheets 101, and the electromagnetic steel sheets constituting the rotor core 30 are referred to as core sheets 301.

The core sheets 101 and the core sheets 301 are punched from the common electromagnetic steel sheet 103 by using pressing machine. Since the circular core sheets 301 are punched on inner regions of the annular core sheets 101, the electromagnetic steel sheet 103 can be effectively used.

The core sheets 101 can be punched in rows and columns as represented by the X direction and the Y direction in FIG. 13. Each of the core sheets 101 includes four non-contact portions 15 at equal intervals in the circumferential direction, and thus falls within a square region. Accordingly, intervals in the X direction and intervals in the Y direction between the core sheets 101 can be reduced, and thus the electromagnetic steel sheet 103 is less wasted and can be further effectively used.

As described with reference to FIG. 4, the radius of curvature Ra of the first corner portion 5a is smaller than the radius of curvature Rb of the second corner portion 5b in the stator core 10. In a case where the radius of curvature Ra is less than a thickness H of the electromagnetic steel sheet 103, chipping of a punch or a die of the pressing machine may occur. When chipping of the punch or the die of the pressing machine occurs, it may cause burrs at the first corner portion 5a, and the insulating film of the coil 21 constituting the winding 20 may be damaged.

For this reason, the radii of curvatures Ra and Rb of the corner portions 5a and 5b preferably satisfy H≤Ra<Rb. When the radii of curvatures Ra and Rb of the corner portions 5a and 5b are within this range, it is possible to suppress occurrence of burrs at the first corner portion 5a to thereby enhance reliability of the winding 20, while suppressing stress concentration.

The features concerning the radii of curvatures Ra and Rb of the corner portions 5a and 5b described above are not limited to the teeth 12A and 12E and are applicable to other teeth 12 in which the distances La and Lb satisfy La<Lb and the distances Da and Db satisfy Da>Db.

### Advantages of Embodiment

As described above, the stator 1 according to the first embodiment includes the stator core 10 including the core back 11 having an annular shape and a plurality of teeth 12 extending from the core back 11 inward in the radial direction, and the stator core 10 is fixed inside the shell 25. The outer circumference of the core back 11 has the contact portions 14a and 14b in contact with the shell 25 and the non-contact portion 15 not in contact with the shell 25. The root portion of the tooth 12A includes the first corner portion 5a on the first side and the second corner portion 5b on the second side. The shortest distance La from the first corner portion 5a to the outer circumference of the core back 11 and the shortest distance Lb from the second corner portion 5b to the outer circumference of the core back 11 satisfy La<Lb. The shortest distance Da from the first corner portion 5a to the first contact portion 14a and the shortest distance Db from the second corner portion 5b to the second contact portion 14b satisfy Da>Db. The radius of curvature Ra of the first corner portion 5a and the radius of curvature Rb of the second corner portion 5b satisfy Ra<Rb.

Since the shortest distances La and Lb satisfy La<Lb and the shortest distances Da and Db satisfy Da>Db as above, stress is concentrated on the second corner portion 5b if the radii of curvatures Ra and Rb of the corner portions 5a and 5b are equal. However, since the radii of curvatures Ra and Rb satisfy the relationship of Ra<Rb as described above, stress concentration on the second corner portion 5b can be suppressed. Since stress concentration in the stator core 10 is suppressed, a local increase of magnetic resistance can be suppressed, and motor efficiency can be increased.

In addition, since the shortest distances La and Lb satisfy Lb/La≥1.16, the effect of reducing stress concentration by making the radii of curvatures Ra and Rb of the corner portions 5a and 5b satisfy Ra<Rb is especially significant.

Further, since the shortest distances La, Lb, Da, and Db satisfy (Lb/La)/(Db/Da)≥1.95, the effect of reducing stress concentration by making the radii of curvatures Ra and Rb of the corner portions 5a and 5b satisfy Ra<Rb is especially significant.

Since the first corner portion 5a and the second corner portion 5b are located on the inner side of the non-contact portion 15 in the radial direction, stress is likely to be concentrated especially on the second corner portion 5b if the radii of curvatures Ra and Rb of the corner portions 5a and 5b are equal. Thus, the effect of reducing stress concentration by making the radii of curvatures Ra and Rb of the corner portions 5a and 5b satisfy Ra<Rb is especially significant.

Further, when the outer diameter of the coil 21 constituting the winding 20 is represented as D, the radii of curvatures Ra and Rb of the corner portions 5a and 5b satisfy Ra<Rb≤D/2. Thus, the decrease in space factor of the winding 20 in the slot 13 can be suppressed, and a copper loss can be reduced.

When the thickness H of each electromagnetic steel sheet 103 constituting the stator core 10 is represented as H, the radii of curvatures Ra and Rb satisfy H≤Ra<Rb. Thus, it is possible to suppress occurrence of chipping of the punch or the like of the pressing machine in punching the electromagnetic steel sheet 103. Thus, occurrence of burrs at the first corner portion 5a can be prevented, and damage of the winding 20 can be prevented.

The stator core 10 is fixed to the shell 25 by shrink fitting, and is applied with stress from the shell 25 after the shrink fitting. Thus, if the radii of curvatures Ra and Rb are equal, stress is likely to be concentrated on the second corner portion 5b. Since the radii of curvatures Ra and Rb of the corner portions 5a and 5b satisfy Ra<Rb, such stress concentration can be reduced.

### Second Embodiment

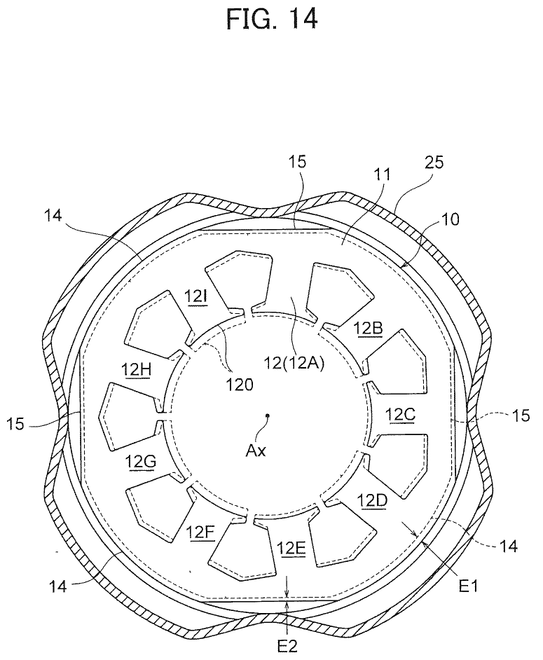

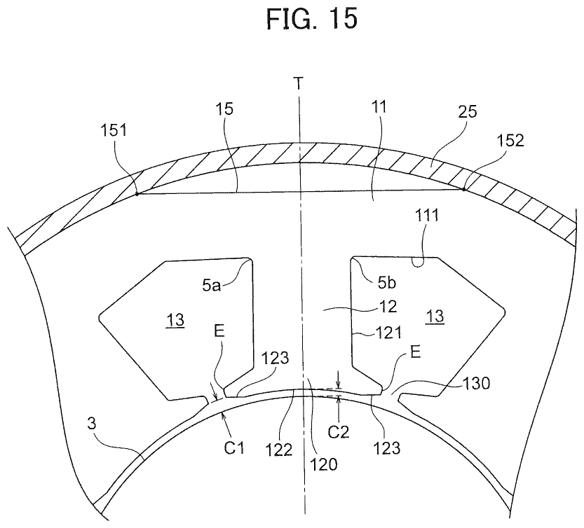

Next, a second embodiment will be described. A stator 1 according to the second embodiment is different from that of the first embodiment in the shape of the tooth tips 120 of the teeth 12. FIG. 14 is a schematic view for describing a state of deformation of the stator core 10 and the shell 25.

As described in the first embodiment, after the stator core 10 is shrink fitted in the shell 25, the shell 25 contracts inward in the radial direction with a decrease in temperature. When the shell 25 contracts, portions of the shell 25 corresponding to the non-contact portions 15 greatly contracts, whereas portions of the shell 25 corresponding to the contact portions 14 do not contract greatly because of resistance of the contact portions 14.

Thus, the shape of the shell 25 becomes a shape as shown by hatching in FIG. 14. In FIG. 14, the shell 25 is shown to protrude outward from the stator core 10 in the radial direction in order to ease understanding of the shape of the shell 25. However, the shell 25 actually contracts inward in the radial direction and is in contact with the stator core 10 at the contact portions 14.

Under stress from the shell 25, the stator core 10 is deformed inward in the radial direction as indicated by broken lines in FIG. 14. Stress applied to the contact portion 14 of the core back 11 from the shell 25 is large, whereas stress applied to the non-contact portion 15 from the shell 25 is small. Thus, a displacement amount E2 of the non-contact portion 15 inward in the radial direction is smaller than a displacement amount E1 of the contact portion 14 inward in the radial direction.

Thus, the teeth 12B, 12D, 12F, and 12I located on the inner side of the contact portions 14 in the radial direction are greatly deformed inward in the radial direction. On the other hand, the teeth 12A, 12C, and 12F located on the inner side of the non-contact portions 15 in the radial direction are relatively less deformed inward in the radial direction.

Since the amount of deformation differs among the teeth 12 as above, the positions in the radial direction of both ends of the tooth tip 120 in the circumferential direction may differ from each other. That is, the distance between the tooth tip 120 and the rotor 3 may be smaller at one end of the tooth tip 120 in the circumferential direction and may be larger at the other end of the tooth tip 120.

FIG. 15 is a diagram illustrating shapes of the teeth 12 of the second embodiment. Each of the teeth 12 of the second embodiment includes retreat portions 123 where the distance from the outer circumference of the rotor 3 (i.e., outer circumference 35 of the rotor core 30 illustrated in FIG. 2) increases, at both ends of the tooth tip portion 120 in the circumferential direction.

Specifically, the tooth tip 120 of each tooth 12 has a tooth tip surface 122 extending in an arc shape along the outer circumference of the rotor 3. The retreat portions 123, which are inclined surfaces inclined with respect to the tooth tip surface 122, are formed at both sides of the tooth tip surface 122 in the circumferential direction.

A distance between the tooth tip 120 and the rotor 3 at ends E of the tooth tip 120 in the circumferential direction is defined as a distance C1. A distance between the tooth tip 120 and the rotor 3 at the center of the tooth tip 120 in the circumferential direction (i.e., on the tooth center line T) is defined as a distance C2. Since the tooth tip 120 includes the retreat portions 123, the distances C1 and C2 satisfy C1>C2.

Since the tooth tip 120 has such a shape, even in a case where one end of the tooth tip 120 in the circumferential direction projects inward in the radial direction, interference between the tooth tip 120 and the rotor 3 can be prevented. Thus, vibration and noise during rotation of the rotor 3 can be suppressed.

Although the tooth tips 120 of all the teeth 12 of the stator core 10 has the retreat portions 123 in this example, this embodiment is not limited to such a configuration. For example, the retreat portions 123 may be provided only on teeth 12 (for example, the teeth 12A and 12F) on the outer circumference side of which the core back 11 has an asymmetric shape.

As described above, in the second embodiment, the distance C1 from the tooth tip 120 to the rotor 3 at the ends E of the tooth tip 120 in the circumferential direction is larger than the distance C2 from the tooth tip 120 to the rotor 3 at the center of the tooth tip 120 in the circumferential direction. Thus, even in a case where the tooth tip 120 of the tooth 12 is deformed asymmetrically, interference between the tooth tip 120 and the rotor 3 can be prevented. As a result, vibration and noise during rotation of the rotor 3 can be suppressed.

### Configuration of Shell

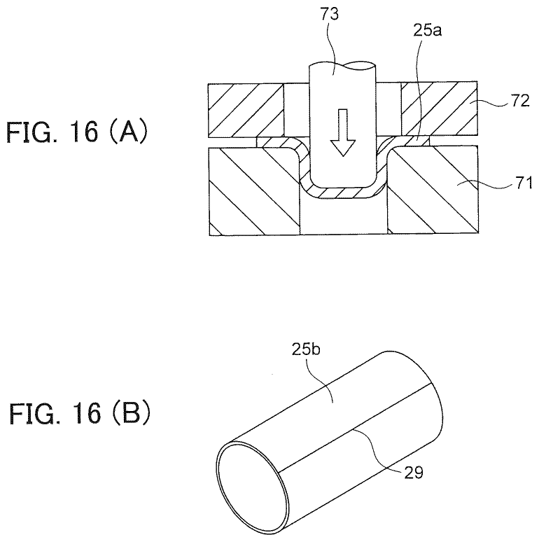

Next, the shell 25 to which the motor 100 of the first or second embodiment is attached will be described. The shell 25 is formed by, for example, deep drawing of a steel sheet. As illustrated in FIG. 16(A), a pressing machine 70 including a die 71, a hold plate 72, and a punch 73 is used for the deep drawing.

In the deep drawing, a steel sheet is plastically deformed by the die 71 and the punch 73 to obtain a shape of a shell 25a, and thus the seamless shell 25a having high rigidity can be obtained. However, in order to control the inner diameter of the shell 25a with high accuracy, maintenance of the die 71 and the punch 73 is necessary, and manufacturing cost increases.

For this reason, as illustrated in FIG. 16(B), it is preferable to form a shell 25b by rounding the steel sheet into a cylindrical shape and welding joint portions 29 thereof. In this case, maintenance of the pressing machine is unnecessary, and thus manufacturing cost can be reduced. However, since the shell 25b has the joint portions 29, rigidity of the shell 25b is lower than that of the shell 25a (FIG. 16(A)) formed by deep drawing.

Thus, when the stator core 10 is fixed to the shell 25a formed by deep drawing and when the stator core 10 is fixed to the shell 25b formed by welding with the same shrink fitting margin, the shell 25b formed by welding has a smaller holding force for holding the stator core 10.

In order to use the shell 25b formed by welding and obtain the holding force which is substantially equal to that of the shell 25a formed by deep drawing, the shrink fitting margin needs to be large. In such a case, stress applied to the stator core 10 from the shell 25b increases.

In the first and second embodiments, stress concentration in the stator core 10 is reduced. Thus, the shell 25b formed by welding can be used and the shrink fitting margin can be increased, so that the stator core 10 can be firmly fixed to the shell 25b.

### Compressor

Next, the compressor 8 using the motor 100 will be described. FIG. 17 is a sectional view illustrating a configuration of the compressor 8. The compressor 8 is a rotary compressor in this example, and includes a shell 80, a compression mechanism 9 disposed inside the shell 80, the motor 100 that drives the compression mechanism 9, and the shaft 90 coupling the motor 100 and the compression mechanism 9 so that a driving force can be transmitted therebetween. The shaft 90 is the shaft 41 illustrated in FIG. 1 and other figures, and is fitted in the center hole 34 of the rotor 3 of the motor 100.

The shell 80 is a closed container formed of, for example, a steel sheet and covers the motor 100 and the compression mechanism 9. The shell 80 includes an upper shell 80a and a lower shell 80b. A glass terminal 81 serving as a terminal part for supplying electric power to the motor 100 from outside of the compressor 8 and a discharge pipe 85 for discharging refrigerant compressed in the compressor 8 to the outside are attached to the upper shell 80a. The lower shell 80b is the shell 25 illustrated in FIG. 1 and other figures, and the motor 100 and the compression mechanism 9 are housed in the lower shell 80b.

The compression mechanism 9 includes an annular first cylinder 91 and an annular second cylinder 92 along the shaft 90. The first cylinder 91 and the second cylinder 92 are fixed to an inner circumferential portion of the shell 80 (lower shell 80b). An annular first piston 93 is disposed on the inner circumference side of the first cylinder 91, and an annular second piston 94 is disposed on the inner circumference side of the second cylinder 92. The first piston 93 and the second piston 94 are rotary pistons that rotate together with the shaft 90.

A partition plate 97 is disposed between the first cylinder 91 and the second cylinder 92. The partition plate 97 is a disc-shaped member having a through hole at the center thereof. In a cylinder chamber of each of the first cylinder 91 and the second cylinder 92, a vane (not shown) is provided to divide the cylinder chamber into a suction side and a compression side. The first cylinder 91, the second cylinder 92, and the partition plate 97 are fixed as one unit with bolts 98.

An upper frame 95 is disposed above the first cylinder 91 to close the upper side of the cylinder chamber of the first cylinder 91. A lower frame 96 is disposed below the second cylinder 92 to close the lower side of the cylinder chamber of the second cylinder 92. The upper frame 95 and the lower frame 96 rotatably support the shaft 90.

A bottom portion of the lower shell 80b of the shell 80 stores refrigerating machine oil (not illustrated) for lubricating sliding portions of the compression mechanism 9. The refrigerating machine oil rises in a hole 90a formed in the shaft 90 in the axial direction and is supplied to the sliding portions through oil supply holes 90b formed at a plurality of positions in the shaft 90.

The stator 1 of the motor 100 is attached to the inner side of the shell 80 by shrink fitting. Electric power is supplied to the winding 20 of the stator 1 from the glass terminal 81 attached to the upper shell 80a. The shaft 90 is fixed to the center hole 34 (FIG. 1) of the rotor 3.

An accumulator 87 for storing a refrigerant gas is attached to the shell 80. The accumulator 87 is held by, for example, a holder 80c disposed on the outer side of the lower shell 80b. A pair of suction pipes 88 and 89 are attached to the shell 80, and a refrigerant gas is supplied from the accumulator 87 to the cylinders 91 and 92 through the suction pipes 88 and 89.

As refrigerant, R410A, R407C, or R22 may be used, for example. From the viewpoint of preventing global warming, refrigerant having a low global warming potential (GWP) is preferably used. As the low-GWP refrigerant, the following refrigerants can be used, for example.
(1) First, halogenated hydrocarbon having a double bond of carbon in its composition, such as hydro-fluoro-orefin (HFO)-1234yf (CF₃CF═CH₂) can be used. The GWP of HFO-1234yf is 4.
(2) Further, hydrocarbon having a double bond of carbon in its composition, such as R1270 (propylene), may be used. R1270 has a GWP of 3, which is smaller than that of HFO-1234yf, but has flammability higher than that of HFO-1234yf.
(3) A mixture containing at least one of halogenated hydrocarbon having a double bond of carbon in its composition or hydrocarbon having a double bond of carbon in its composition, such as a mixture of HFO-1234yf and R32, may be used. Since HFO-1234yf described above is a low-pressure refrigerant, a pressure loss tends to increase, and performance of a refrigeration cycle (especially an evaporator) may degrade. Thus, it is practically preferable to use a mixture with R32 or R41, which is a higher-pressure refrigerant than HFO-1234yf.

Basic operation of the compressor 8 is as described below. A refrigerant gas supplied from the accumulator 87 is supplied to the cylinder chambers of the first cylinder 91 and the second cylinder 92 through the suction pipes 88 and 89. When the motor 100 is driven to rotate the rotor 3, the shaft 90 rotates together with the rotor 3. Then, the first piston 93 and the second piston 94 fitted in the shaft 90 eccentrically rotate in the cylinder chambers, and compress refrigerant in the cylinder chambers. The compressed refrigerant passes through the holes 36 and 37 (FIG. 2) of the rotor 3 and moves upward in the shell 80, and is discharged to the outside from the discharge pipe 85.

The compressor using the motor 100 is not limited to the rotary compressor, and may be a scroll compressor or the like.

The motor 100 of each embodiment achieves a high motor efficiency by suppression of stress concentration in the stator 1, and reduces vibration and noise by preventing contact between the rotor 3 and the stator 1. Accordingly, quietness and operating efficiency of the compressor 8 can be enhanced.

### Refrigeration Cycle Apparatus

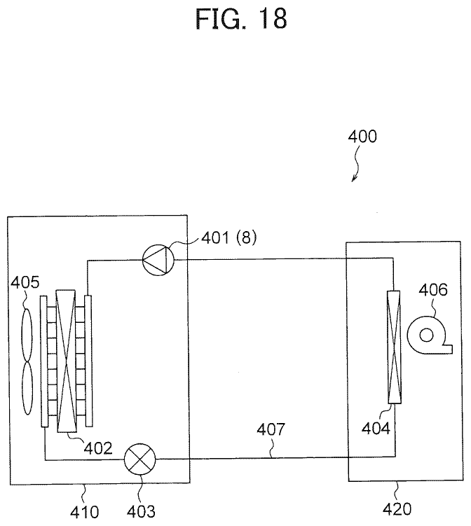

Next, a refrigeration cycle apparatus 400 including the compressor 8 illustrated in FIG. 17 will be described. FIG. 18 is a diagram illustrating the refrigeration cycle apparatus 400. The refrigeration cycle apparatus 400 is, for example, an air conditioner, but is not limited to the air conditioner and may be, for example, a refrigerator.

The refrigeration cycle apparatus 400 illustrated in FIG. 18 includes a compressor 401, a condenser 402 that condenses refrigerant, a decompressor 403 that decompresses the refrigerant, and an evaporator 404 that evaporates the refrigerant. The compressor 401, the condenser 402, and the decompressor 403 are disposed in an outdoor unit 410, and the evaporator 404 is disposed in the indoor unit 420.

The compressor 401, the condenser 402, the decompressor 403, and the evaporator 404 are coupled to one another by a refrigerant pipe 407, and constitute a refrigerant circuit. The compressor 401 is the compressor 8 illustrated in FIG. 17. The refrigeration cycle apparatus 400 also includes an outdoor fan 405 facing the condenser 402, and an indoor fan 406 facing the evaporator 404.

Operation of the refrigeration cycle apparatus 400 is as follows. The compressor 401 compresses sucked refrigerant and sends out the compressed refrigerant as a high-temperature and high-pressure refrigerant gas. The condenser 402 performs heat exchange between the refrigerant sent from the compressor 401 and outdoor air sent by the outdoor fan 405, condenses the refrigerant, and sends out the condensed refrigerant as liquid refrigerant. The decompressor 403 causes liquid refrigerant sent from the condenser 402 to expand, and sends out the expanded refrigerant as low-temperature and low-pressure liquid refrigerant.

The evaporator 404 performs heat exchange between indoor air and the low-temperature and low-pressure liquid refrigerant sent from the decompressor 403, evaporates (vaporizes) the refrigerant, and sends out the refrigerant as a refrigerant gas. Air from which heat is taken by the evaporator 404 is supplied by the indoor fan 406 into a room that is a space to be air-conditioned.

Since the motor 100 described in each embodiment is applicable to the compressor 401 of the refrigeration cycle apparatus 400, quietness and operating efficiency of the refrigeration cycle apparatus 400 can be enhanced.

Although the preferred embodiments have been specifically described above, the present disclosure is not limited to the embodiments described above, and various improvements and modifications may be made.

1. A stator comprising:
a stator core comprising a core back having an annular shape about an axis and a plurality of teeth extending from the core back inward in a radial direction about the axis, the stator core being fixed inside a shell,
wherein the core back has an outer circumference facing the shell, the outer circumference having a first contact portion and a second contact portion which are in contact with the shell and a non-contact portion which is not in contact with the shell,
wherein, in a circumferential direction about the axis, the first contact portion is located on a first side of the non-contact portion, and the second contact portion is located on a second side of the non-contact portion,
wherein the plurality of teeth include a first tooth,
wherein the first tooth has a root portion connecting to the core back, the root portion having a first corner portion on the first side and a second corner portion on the second side,
wherein a shortest distance La from the first corner portion to the outer circumference and a shortest distance Lb from the second corner portion to the outer circumference satisfy La<Lb,
wherein a shortest distance Da from the first corner portion to the first contact portion and a shortest distance Db from the second corner portion to the second contact portion satisfy Da>Db, and
wherein a radius of curvature Ra of the first corner portion and a radius of curvature Rb of the second corner portion satisfy Ra<Rb.

2. The stator according to claim 1, wherein the shortest distance La and the shortest distance Lb satisfy Lb/La≥1.16.

3. The stator according to claim 1, wherein the shortest distance La, the shortest distance Lb, the shortest distance Da, and the shortest distance Db satisfy:
$$( Lb / La ) / ( Db / Da ) \geq 1.95 .$$

4. The stator according to claim 1, wherein the first corner portion and the second corner portion are located on an inner side of the non-contact portion in the radial direction.

5. The stator according to claim 1, further comprising a winding wound around the stator core, and
wherein when an outer diameter of a coil constituting the winding is expressed as D, the radius of curvature Ra and the radius of curvature Rb satisfy Ra<Rb≤D/2.

6. The stator according to claim 1, wherein when a thickness of an electromagnetic steel sheet constituting the stator core is expressed as H, the radius of curvature Ra and the radius of curvature Rb satisfy H≤Ra<Rb.

7. The stator according to claim 1, wherein the stator core is fixed to the shell by shrink fitting.

8. The stator according to claim 1, wherein the shell is a metal plate bent in a cylindrical shape and welded.

9. The stator according to claim 1, wherein at least one of the plurality of teeth has a tooth tip, and
wherein each end portion of the tooth tip in the circumferential direction has an inclined portion that is inclined in a direction away from the axis.

10. A motor comprising:
the stator according to claim 1; and
a rotor located inside the stator.

11. The motor according to claim 10, wherein at least one of the plurality of teeth has a tooth tip facing the rotor, and
wherein a distance C1 from an end of the tooth tip in the circumferential direction to the rotor is longer than a distance C2 from a center of the tooth tip in the circumferential direction to the rotor.

12. A compressor comprising:
the motor according to claim 11; and
a compression mechanism driven by the motor.

13. A refrigeration cycle apparatus comprising:
the compressor according to claim 12;
a condenser;
a decompressor; and
an evaporator.

14. The stator according to claim 1, wherein the outer circumference of the core back has four non-contact portions arranged at equal intervals in the circumferential direction.
